(19) United States
(12) Patent Application Publication
(10) Pub. No.: US 2007/0097424 A1
(43) Pub. Date: May 3, 2007

(54) Printing system and host device

(75) Inventor: Hidekazu Mizuno, Nagano-Ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/542,374

(22) Filed: Oct. 2, 2006

(30) Foreign Application Priority Data
Sep. 30, 2005 (JP) P2005-285932

(51) Int. Cl. G06F 3/12

(52) U.S. Cl. 358/1.15

(57) ABSTRACT

A printer is communicatively connected to a host device. A first transmitter is operable to transmit an inquiry to the printer for acquiring a status of the printer, and to transmit a printing request to the printer. A detector is operable to detect the inquiry and the printing request from the host device. A printing section is operable to perform printing with respect to a printing medium, in accordance with the printing request. A second transmitter is operable to transmit the status to the host device in response to the inquiry. A power saving controller is operable to switch the printer between a first state in which the second transmitter is activated and a second state in which the second transmitter is deactivated. The first transmitter is operable to transmit the inquiry every first time period in a case where the printer is in the first state. The first transmitter is operable to transmit the inquiry every second time period which is longer than the first time period or to stop transmitting the inquiry in a case where the printer is in the second state.

The disclosure of Japanese Patent Application No. 2005-285932 filed Sep. 30, 2005 including specification, drawings and claims is incorporated herein by reference in its entirety.

### BACKGROUND OF THE INVENTION

The present invention relates to technology for suppressing power consumption of a printer.

There has been known a printer which, in case that it does not accept a printing request for a predetermined time in a power-on state, shifts to a power saving mode in order to reduce the power consumed quantity. Particularly, there is a printer which deactivates CPU in this power saving mode.

On the other hand, there is a printer host device which inquires of the printer a status periodically. The printer, upon reception of the inquiry about the status from such the host device, must respond to an inquiry request about the status after restoring the CPU. Therefore, there is a problem that a power saving effect of the printer is reduced. In view of such the problem, some inventions have been made, for example, Japanese Patent Publication NO. 11-219263 and Japanese Patent Publication No. 2004-34488.

In Japanese Patent Publication No. 11-219263, technology is described in which a period of making a status inquiry for the printer by the host device can be changed by user's setting.

In Japanese Patent Publication No. 2004-34488, a printer is described, which deactivates a main CPU in a power saving mode, and includes a sub-CPU for responding to a status inquiry in this time.

However, in the technology in Japanese Patent Publication No. 11-219263, to utilize the printer comfortably while increasing the power saving effect, the user must set and release the period. Therefore, in order to increase the power saving effect, the user must frequently set and release the period, which is troublesome.

Further, the printer in Japanese Patent Publication No. 2004-34488 has the sub-CPU, which causes increase of cost.

### SUMMARY OF THE INVENTION

Therefore, it is an object of the invention to increase a power saving effect of a printer without giving a load to a user and increasing the number of parts.

In order to achieve the above objects, according to the invention, there is provided a printing system comprising:
a host device;
a printer, communicatively connected to the host device, wherein:
the host device includes:
   a first transmitter, operable to transmit an inquiry to the printer for acquiring a status of the printer, and to transmit a printing request to the printer;
the printer includes:
   a detector, operable to detect the inquiry and the printing request from the host device;
   a printing section, operable to perform printing with respect to a printing medium, in accordance with the printing request;
   a second transmitter, operable to transmit the status to the host device in response to the inquiry; and
   a power saving controller, operable to switch the printer between a first state in which the second transmitter is activated and a second state in which the second transmitter is deactivated;
the first transmitter is operable to transmit the inquiry every first time period in a case where the printer is in the first state; and
the first transmitter is operable to transmit the inquiry every second time period which is longer than the first time period or to stop transmitting the inquiry in a case where the printer is in the second state.

According to the invention, there is also provided a host device adapted to be communicatively connected to a printer, the host device comprising:
a transmitter, operable to transmit an inquiry to the printer for acquiring a status of the printer, wherein:
the transmitter is operable to transmit the inquiry every first time period in a case where the printer is in a first state in which the printer is operable to transmit the status; and
the transmitter is operable to transmit the inquiry every second time period which is longer than the first time period or to stop transmitting the inquiry in a case where the printer is in a second state in which the printer is not operable to transmit the status.

According to the invention, there is also provided a method performed by a host device for inquiring a status of a printer which is communicatively connected to the host device, the method comprising:
transmitting an inquiry to the printer; and
acquiring the status from the printer in response to the inquiry, wherein:
the inquiry is transmitted every first time period in a case where the printer is operable to transmit the status; and
the inquiry is transmitted every second time period which is longer than the first time period in a case where the printer is not operable to transmit the status.

### BRIEF DESCRIPTION OF THE DRAWINGS

The above object and advantages of the invention will become more apparent by describing in detail preferred and exemplary embodiments with reference to the accompanying drawings.

FIG. 1 is a diagram showing the constitution of a printing system according to an embodiment of the invention;

FIG. 2 is a diagram showing the functional constitution of the printing system according to the embodiment of the invention;

FIG. 3 is a flowchart of a host device;

FIG. 4 is another flowchart of the host device;

FIG. 5 is a flowchart of a printer; and

FIG. 6 is a flowchart of the printer.

### DETAILED DESCRIPTION OF THE EMBODIMENTS

Hereinafter, a printing system according to one embodiment of the invention will be described with reference to drawings.

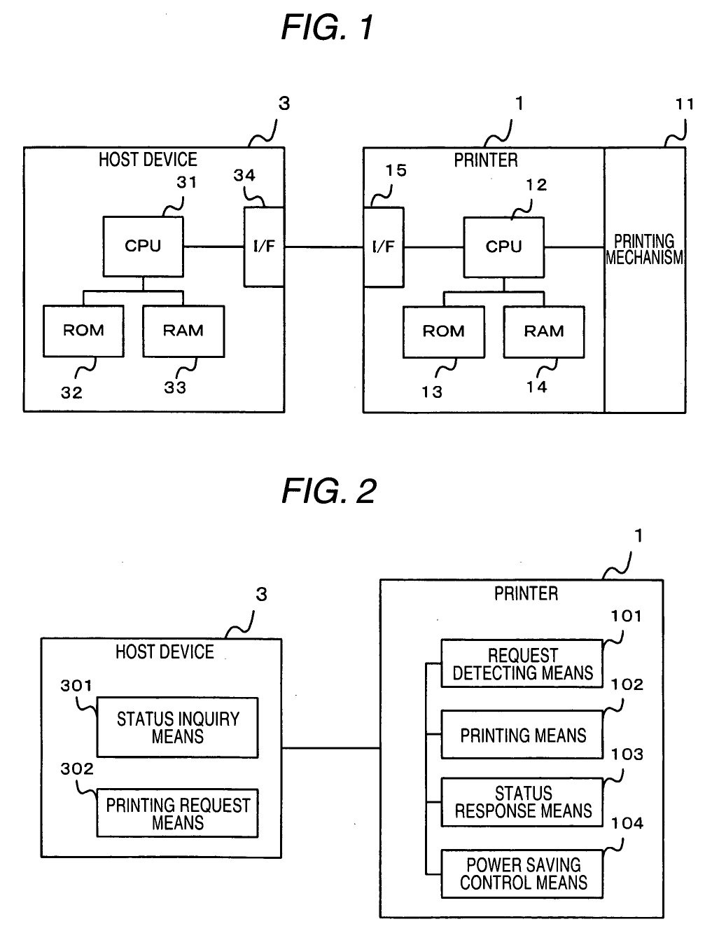

FIG. 1 is a diagram showing the constitution of a printing system according to one embodiment of the invention.

This system includes a printer 1 and a printer host device (hereinafter referred to as a host device) 3.

The printer 1 includes a printing mechanism 11 having a print head, a carriage on which the print head is mounted, and a paper feed mechanism; a CPU 12 which executes a program stored in a ROM 13 and controls the printing mechanism 11; a RAM 14 which is used when the CPU 12 executes the program; and an interface 15 with the host device 3.

The host device 3 may be constituted by a general-purpose computer machine such as a personal computer. Namely, the host device 3 includes a CPU 31 which executes a predetermined program stored in a ROM 32; a RAM 33 which is used when the CPU 21 executes the program; and an interface 34 with the printer 1.

FIG. 2 is a diagram showing the functional constitution realized by executing the respective predetermined programs by the printer 1 and the host device 3 which include the above hardware construction.

The host device 3, as shown in FIG. 2, includes a status inquiry means 301 which inquires of the printer 1 about a status, and a printing request means 302 which generates printing data, transmits the printing data to the printer 1, and requests printing. The status inquiry means 301 and the printing request means 302 are implemented by the CPU 31.

The status inquiry means 301 transmits a status inquire request to the printer 1, and acquires information indicating the status of the printer 1 as a response to the inquire request. Timing in which the status inquiry for the printer 1 is made may be arbitrary timing such as when an instruction is given by a user, or may be periodical timing at predetermined intervals. The control of the status inquiry timing will be described later.

The printing request means 302 generates printing data, transmits this printing data to the printer 1, and makes a printing request.

The printer 1, as shown in FIG. 2, includes a request detecting means 101 which detects the request transmitted from the host device 3, a printing means 102 which executes printing on the basis of the printing data transmitted from the host device 3, a status response means 103 which transmits the status of the printer 1 in response to the status inquiry from the host device 3, and a power saving control means 104 which controls operation modes of the printer in order to save electric power consumed by the printer 1.

The request detecting means 101 is implemented by the interface 15 (refer to FIG. 1), and detects, upon reception of any request from the host device 3, its request. For example, in the embodiment, since the host device 3 transmits the status inquiry request and the printing request to the printer 1, the interface 15 (request detecting means 101), upon reception of either request from the host device 3, detects its request, and interrupts the CPU 12 (refer to FIG. 1). The CPU 12 knows from this interruption that the request from the host device 3 has been received.

In case that the received request is the printing request, the printing means 102 implemented by the CPU 12 and the printing mechanism 11 executes printing processing. Further, in case that the received request is the status inquiry request, the status response means 103 implemented by the CPU 12 transmits a present status of the printer 1 to the host device 3.

The power saving control means 104, which is implemented by the CPU, controls the operation modes of the printer 1 thereby to reduce power consumption of the printer 1. Here, the operation modes of the printer 1 include the following three kinds.

(1) Normal operation mode (hereinafter referred to as a normal mode) in which all of the request detecting means 101, the printing means 102 and the status response means 103 are activated.

(2) Sleep mode in which the printing means 102 is deactivated, and the request detecting means 101 and the status response means 103 are activated.

(3) Standby mode in which the printing means 102 and the status response means 103 are deactivated, and only the request detecting means 101 is activated.

The normal mode indicates an immediate response-enabled state in relation to the status inquiry request and the printing request from the host device 3. The normal mode is largest in power consumption of the three modes. In the normal mode, when a waiting state where the printing request from the host device 3 is waited continues for a predetermined time (T1) or more, the printer 1 shifts to the sleep mode.

The sleep mode is a first power saving mode in which the printing means 102 is deactivated and the power consumption is reduced. In the sleep mode, for example, a not-shown panel lighting for interface is turned off, or each motor included in the printing mechanism 11 (refer to FIG. 11) is unexcited. Further, at this time, a clock of the CPU 12 is operating.

When the printer 1 receives the printing request in the sleep mode, the power saving control means 104 restores the printer 1 to the normal mode, and the printing means 102 executes printing in accordance with the printing request. Therefore, it takes more time to make the response than in the normal mode by the time necessary for the printer 1 to be restored from the sleep mode to the normal mode.

On the other hand, even in the sleep mode, the status response means 103 is operating. Therefore, the status response means 103, upon reception of the status inquiry request from the host device 3, immediately responds to the inquiry and transmits the status in that time (i.e., “sleep”).

In the sleep mode, when the printer 1 does not accept any request from the host device 3 for a predetermined time (T2) or more, it shifts to the standby mode.

The standby mode is a second power saving mode in which the printing means 102 and the status response means 103 are deactivated. In the standby mode, in addition to the state in the sleep mode, the clock of the CPU 12 is also deactivated. Namely, substantially, only the host device 3 and interface 15 (request detecting means 101) of the components which the printer 1 has are operating. Therefore, the standby mode is lower in power consumption than the sleep mode.

When the request detecting means 101 interrupts the CPU 12 in the state where the printer 1 is in the standby mode, the clock of the CPU 12 restarts to operate, and the printer 1 enters the sleep mode. Here, when the request detected by the request detecting means 101 is the status inquiry request, the status response means 103 transmits the status in that time (i.e., “sleep”) in the state where the printer is in the sleep mode.

On the other hand, when the detected request is the printing request, the printer 1 is further restored from the sleep mode to the normal mode, and the printing means 102 performs printing processing of printing data relating to the printing request.

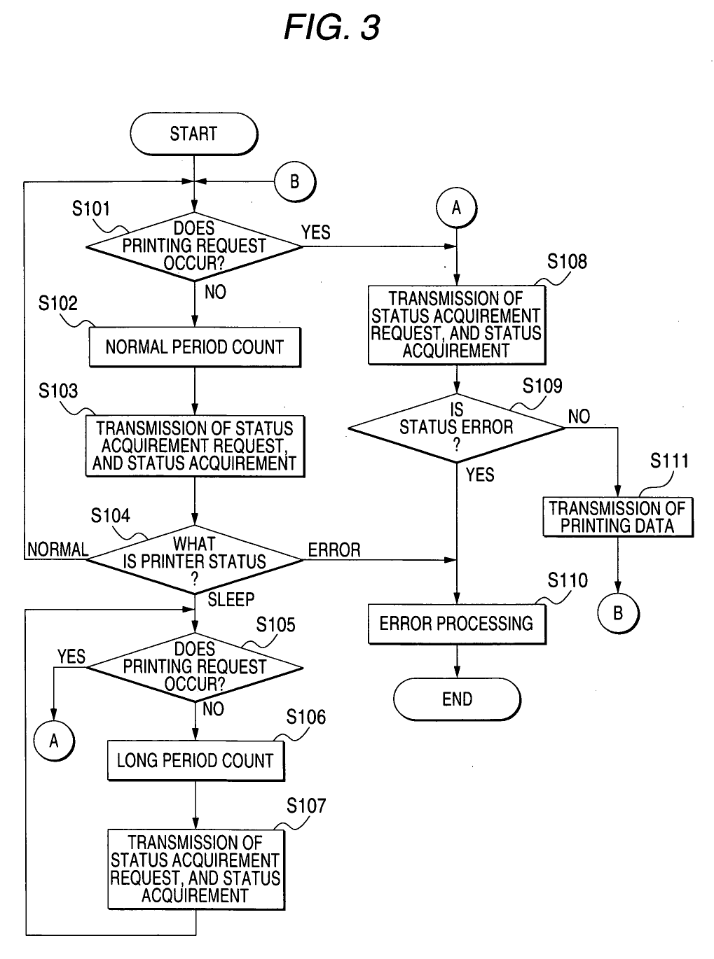

Next, FIG. 3 shows a flowchart of processing executed by the host device 3.

The host device 3 checks whether or not there is a printing request for the printer 1 (S101). When there is no printing request (S101: No), the host device 3 counts elapsed time. When the time set as a normal period elapses, the status inquiry means 301 transmits a status inquiry request to the printer 1 and acquires the status of the printer 1 (S102, S103).

Here, in case that the status of the printer 1 is the “normal mode”, the host device 3 returns to the step S101 (S104).

In case that the status of the printer 1 is “error”, the host device 3 executes error processing (S110).

In case that the status of the printer 1 is the “sleep mode”, the host device 3 checks whether or not there is the printing request for the printer 1 (S105). Here, when there is no printing request, the host device 3 counts elapsed time after the last status acquiring time. When time in a period which is longer (long period) than the normal period in the step S102 passes, the status inquiry means 301 transmits the status inquiry request to the printer 1 and acquires the status of the printer 1 (S106, S107). Next, the host device 3 returns to the step S105 and repeats processing from the step S105 on.

When there are the printing requests in the step S101 and in the step S105, the status inquiry means 301 transmits the status inquiry request to the printer 1 and acquires the status of the printer 1 (S108). In case that the acquired status is “error” (S109: Yes), the host device 3 executes error processing (S110).

In case that the acquired status is not “error” (S109: No), the printing request means 302 generates printing data and transmits its data to the printer (S111). Next, the host device returns to the step S101 and continues the processing.

As described in the above processing, the host device 3, when the printer 1 is in the sleep mode, inquires about the printer status in the time period which is longer than the time period in the normal mode. Namely, according to the embodiment, the host device 3, in accordance with the status of the printer 1, can change the time period in which the status is acquired.

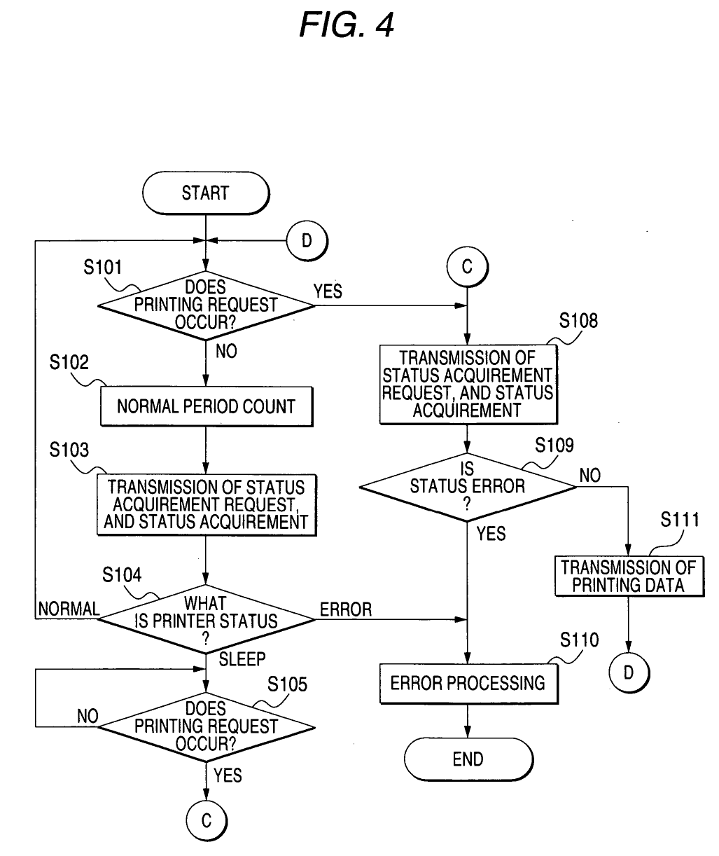

Further, FIG. 4 shows a flowchart of another processing executed by the host device 3.

In this procedure, as shown in FIG. 4, the steps S106 and S107 in FIG. 3 are omitted. Namely, the host device 3, when detecting that the status of the printer 1 is the sleep mode, does not perform the status acquirement till a next printing request occurs. Further, the status acquirement may be performed when an event to inquire about the status of the printer occurs in the printer host device. As the event, a case where a next printing request occurs, or a case where a user gives an instruction of displaying the newest status of the printer on a screen of the printer host is thought.

According to the above embodiment, when the printer is in the power saving mode, the time period of the status inquiry for the printer is made longer, or the inquiry is not made. In this result, because of the later described reasons, the printer 1 can be power-saved more.

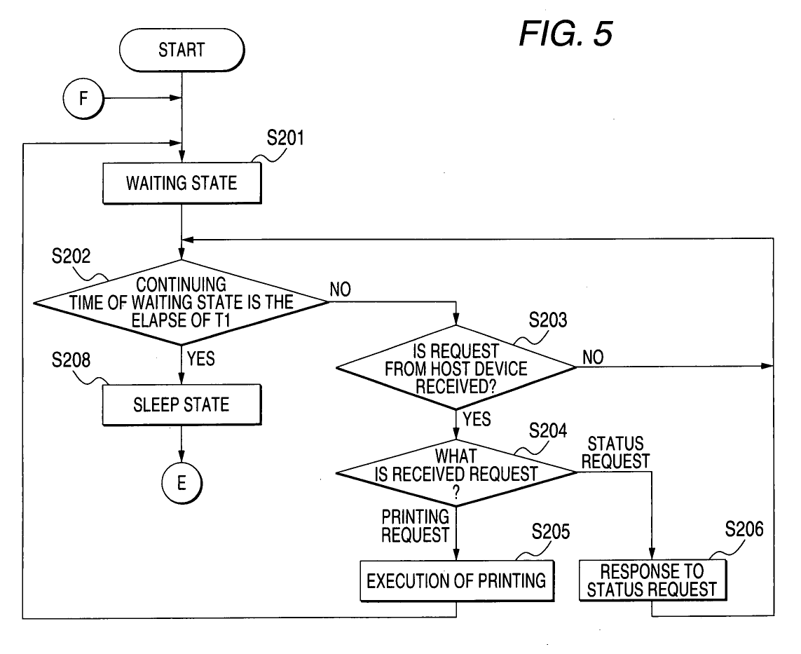

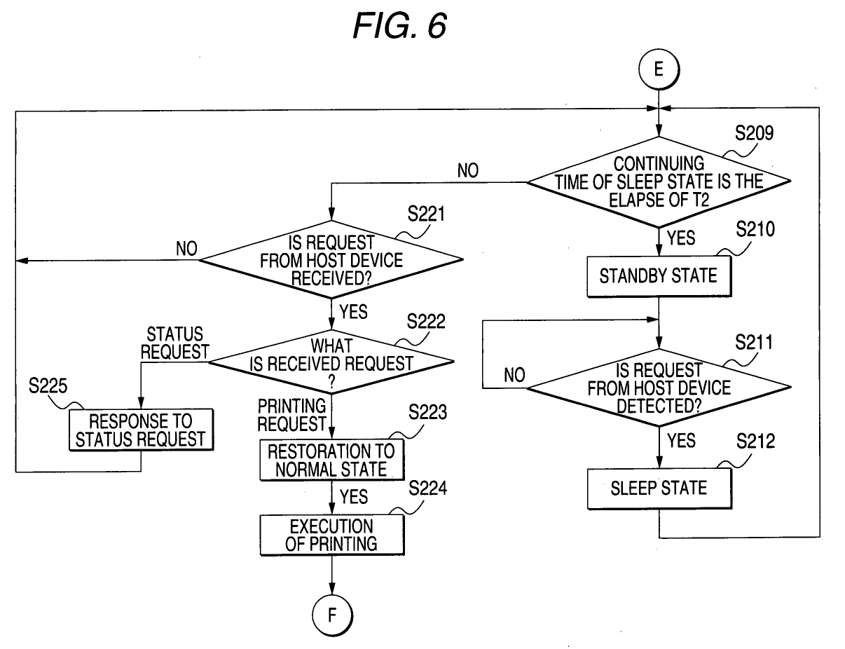

Next, FIGS. 5 and 6 show flowcharts of processing executed by the printer 1.

Firstly, when the printer 1 is switched on, it enters a waiting state where it waits a request from the host device 3 (S201). Next, the printer 1 counts elapsed time after the waiting state. In case that the elapse time is below the predetermined time (T1) (S202: No), the printer 1 checks whether or not there is reception of any request from the host device 3 (203).

When the host device 3 has not received any request from the printer 1 (S203: No), the printer returns to the step S202.

On the other, when the printer 1 has received any request from the host device 3, it judges a kind of its request (S204). When the received request is a printing request, the printer executes printing in accordance with the printing data received by the printing means 102 and returns to the step S201 (S205). To the contrary, when the received request is a status acquirement request, the status response means 103 transmits the present status of the printer 1 i.e., “normal”) to the host device 3 in response to the request and returns to the step S202 (S206).

In the step S202, when the elapsed time after the waiting state of the printer 1 exceeds T1 (S202: Yes), the printer 1 shifts to the sleep mode (S208).

Referring to FIG. 6, the printer 1 counts elapsed time after the sleep mode. When the elapsed time exceeds a predetermined time (T2) (S209: Yes), the printer 1 shifts to the standby mode (S210).

Here, the printer 1, till the request detecting means 101 accepts the request from the host device 3, continues the standby mode state (S211). When the request detecting means 101 detects the request from the host device 3 (S211: Yes), the printer 1 is restored to the sleep mode and returns to the step S209.

Namely, when the printer 1 is in the standby mode in which the power saving effect is largest, it continues the standby mode state till it accepts any request from the host device 3. Therefore, as described above, when the host device 3 detects that the printer 1 has entered the sleep mode, the time period of the status inquiry made for the printer 1 becomes long. Therefore, the time period in which the printer 1 is in the standby mode becomes long, so that power-saving effect becomes larger.

Here, as clear from the above description, since the response to the status inquiry is impossible in the standby mode, the power saving mode detected by the host device 3 is always the sleep mode. However, such setting of T2 as to become shorter greatly than the long period of the status inquiry, when the host device 3 detects the sleep mode, makes it possible that the printer is substantially in the standby mode.

Continuing the description of the flowchart, when the continuation time of the sleep mode is below T2 (S209: No), the printer judges the presence or absence of the request from the host device 3 (S221). When the printer has not received any request from the host device 3 (S221: No), it returns to the step S209.

On the other, when the printer has received the request from the host device 3, it judges a kind of its request (S222). When the received request is a printing request, the status of the printer 1 is restored to the normal mode, and the printer executes printing in accordance with the printing data received by the printing means 102 (S223, S224). After completion of printing, the printer returns to the step S201. When the request from the host device 3 is a status acquirement request, the printer 1 transmits the present status to the host device 3 in response to the request, and the printer returns to the step S209 (S225).

In the above embodiment, a plurality of the means (status inquiry means 302, printing request means 302) provided for the host device correspond to the CPU 31. Further, the request detecting means provided for the printer corresponds to the interface 15, and the status response means and the power saving control means correspond to the CPU 12. The function of each means may be realized by execution of the programs by one CPU or plural CPU's, or may be realized by one hardware unit or plural hardware units.

In the above embodiment, as the power-saving states of the printer 1, there are the sleep mode in which the printing means 102 is deactivated, and the status response means 103 is activated; and the standby mode in which the printing means 102 and the status response means 103 are deactivated. Namely, at least the state where the printing means 102 is deactivated is set as the power saving state. However, regardless of the operation of the printing means 102, the state where the status response means 103 is deactivated may be set as the power saving state, or the state where at least either the printing means 102 or the status response means 103 is deactivated may be set as the power saving state.

In the above embodiment, the power saving mode which is detected by the host device 3 is the “sleep mode”. However, the printer 1, before shifting to the “standby mode” (or example, immediately before shifting thereto), may transmit a fact of shifting to the standby mode as the status to the host device 3, whereby the host device 3 can judge the printer 1 to be in the “standby mode”.

In the above embodiment, a condition that the printer shifts to the power saving state is that the waiting state in which the printer is waiting for the printing request from the host device 3 continues for the predetermined time (T1) or more. However, the condition that the printer 1 shifts to the power saving state may be a predetermined condition consisting of an internal factor in the printer or/and an external factor outside the printer. For example, by a command from the host device 3, the printer may be caused to shift to the power saving state. In this case, the host device 3, regardless of the status information from the printer 1, can grasp the power saving state of the printer 1.

In the above embodiment, the host device 3 judges the power saving state of the printer 1 on the basis of the status information transmitted from the printer 1. However, the host device 3 may judge the power saving state on the basis of a predetermined command transmitted from the printer 1 in place of the status. Further, the host device may judge, by a response time till the printer 1 transmits the status to the host device in response to the status inquiry transmitted by the host device, that the printer 1 is in the standby mode.

The above described embodiment of the invention is an illustration for description of the invention, and does not limit the scope of the invention to only this embodiment. It will be obvious to those skilled in the art that the invention can be embodied in several forms without departing from the spirit of the invention.

What is claimed is:

1. A printing system comprising:
a host device;
a printer, communicatively connected to the host device, wherein:
the host device includes:
a first transmitter, operable to transmit an inquiry to the printer for acquiring a status of the printer, and to transmit a printing request to the printer;
the printer includes:
a detector, operable to detect the inquiry and the printing request from the host device;
a printing section, operable to perform printing with respect to a printing medium, in accordance with the printing request;
a second transmitter, operable to transmit the status to the host device in response to the inquiry; and
a power saving controller, operable to switch the printer between a first state in which the second transmitter is activated and a second state in which the second transmitter is deactivated;
the first transmitter is operable to transmit the inquiry every first time period in a case where the printer is in the first state; and
the first transmitter is operable to transmit the inquiry every second time period which is longer than the first time period or to stop transmitting the inquiry in a case where the printer is in the second state.

2. The printing system as set forth in claim 1, wherein:
the first transmitter is operable to transmit the inquiry every first time period in a case where the status indicates that the printer is in the first state; and
the first transmitter is operable to transmit the inquiry every second time period in a case where the status indicates that the printer is in the second state.

3. The printing system as set forth in claim 1, wherein the first transmitter is operable to stop transmitting the inquiry until a predetermined event occurs in the host device.

4. The printing system as set forth in claim 1, further comprising:
a CPU provided in the printer and operable to execute a program for implement the second transmitter, wherein:
a clock of the CPU is paused in a case where the printer is in the second state.

5. The printing system as set forth in claim 1, wherein:
the printing section is deactivated in the first state and the second state; and
the power saving controller is operable to switch the printer from the first state to the second state in a case where the detector detects neither the inquiry nor the printing request for a third time period.

6. The printing system as set forth in claim 5, wherein:
the third time period is shorter than the second time period.

7. The printing system as set forth in claim 5, wherein:
the power saving controller is operable to switch the printer to the first state in a case where the detector detects either the inquiry or the printing request when the printer is in the second state.

8. The printing system as set forth in claim 5, wherein:
the power saving controller is operable to switch the printer to the first state and to activate the printing section in a case where the detector detects the printing request when the printer is in the second state.

9. A host device adapted to be communicatively connected to a printer, the host device comprising:
a transmitter, operable to transmit an inquiry to the printer for acquiring a status of the printer, wherein:
the transmitter is operable to transmit the inquiry every first time period in a case where the printer is in a first state in which the printer is operable to transmit the status; and
the transmitter is operable to transmit the inquiry every second time period which is longer than the first time period or to stop transmitting the inquiry in a case where the printer is in a second state in which the printer is not operable to transmit the status.

10. The host device as set forth in claim 9, wherein:
the first transmitter is operable to transmit the inquiry every first time period in a case where the status indicates that the printer is in the first state; and
the first transmitter is operable to transmit the inquiry every second time period in a case where the status indicates that the printer is in the second state.

11. The host device as set forth in claim 9, wherein the transmitter is operable to stop transmitting the inquiry until a predetermined event occurs in the host device.

12. A method performed by a host device for inquiring a status of a printer which is communicatively connected to the host device, the method comprising:
transmitting an inquiry to the printer; and
acquiring the status from the printer in response to the inquiry, wherein:
the inquiry is transmitted every first time period in a case where the printer is operable to transmit the status; and
the inquiry is transmitted every second time period which is longer than the first time period in a case where the printer is not operable to transmit the status.
